(19) United States
(12) Patent Application Publication
(10) Pub. No.: US 2012/0318077 A1
(43) Pub. Date: Dec. 20, 2012

(54) Ergonomically enhanced System and Method for Handwriting

(76) Inventor: Roy PACA, Annapolis, MD (US)

(21) Appl. No.: 13/524,677

(22) Filed: Jun. 15, 2012

Related U.S. Application Data
(60) Provisional application No. 61/497,485, filed on Jun. 15, 2011.

(51) Int. Cl. G09B 11/00

(52) U.S. Cl. 73/865.4

(57) ABSTRACT

A handwriting method and system includes a lined paper or handwriting sensing and recording surface with indicia ergonomically aligned along a first slanted axis that is specifically and uniquely configured to writers who are right handed. In accordance with the present invention, a second set of stationery products includes a lined paper or handwriting sensing and recording surface having indicia aligned along a second slanted axis that is specifically and uniquely configured to writers who are left-handed. A tablet configured in accordance with the present invention is made from a conventional substrate such as paper, and the printed indicia aligned along the selected slanted axis allows the writer to adopt a more relaxed and ergonomic or naturally aligned body position when writing, thereby increasing the comfort and efficiency of writing. The system and method are readily adapted as a programmed display for use with electronic wireless tablets.

### PRIORITY CLAIMS AND CROSS-REFERENCE TO RELATED APPLICATIONS

This application claims priority to and is related to commonly owned and co-pending U.S. provisional patent application No. 61/497,485 entitled Stationery System and Ergonomically enhanced Method for Writing and filed Jun. 15, 2011, the entire disclosure of which is incorporated herein by reference.

### BACKGROUND OF THE INVENTION

1. Field of the Invention

The present invention relates to a handwriting method and system optionally including printed matter such as ruled stationery or a wireless electronic tablet that is ergonomically configured for more comfortable, less fatiguing handwriting.

2. Discussion of the Prior Art

Writing can be fatiguing, and traditional stationery, tablets and forms configured for handwriting have traditionally been created without regard to ergonomics or the mechanics of writing. As a result, users of those products have resorted to arranging the stationery or forms as best they can when forced to write for prolonged periods. FIGS. 1A and 1B illustrate the adaptation a typical right-handed writer uses when writing onto a tablet or pad of ruled pages, and shows that a large amount of desk or work space is required for the user who tries to adopt a comfortable writing position.

Training or teaching people to write and specifically teaching handwriting has been complicated by the fact that writers are, by virtue of their structure and posture, pre-disposed to adopt a fatiguing posture for writing and their writing is often set down in a bio-mechanically forced slant, depending on whether the writer is right-handed or left-handed and depending on whether the writer writes with a “straight wrist.” The study of handwriting mechanics is very well developed and informs the educators who strive to teach our youth handwriting. Handwriting movement analysis is the study and analysis of the movements involved in handwriting and drawing and is part of ‘graphonomics’, which became established after the “International Workshop on Handwriting Movement Analysis” in 1982 in Nijmegen, The Netherlands.

Handwriting is historically the widest taught motor skill. It is also one of the first, and often the only motor skill children will learn at elementary school. It traditionally takes years of practice and maturing before a person has mastered what is referred to as ‘the adult handwriting’ skill.

Writers who engage in a handwriting activity for an extended interval often experience strain and fatigue which manifest in an uncomfortable wrist, back, neck and other bodily aches, all of which worsen during writing sessions. The typical handwriting practice (shown in FIG. 1) is ubiquitous, but illustrates the poor Ergonomics of the prior art. Ergonomics (or human factors) is the scientific discipline concerned with the understanding of interactions among humans and other elements of a system, and the profession that applies theory, principles, data and methods to design in order to optimize human well-being and overall system performance. Ergonomics is employed to fulfill the two goals of health and productivity. It is relevant in the design of such things as safe furniture and easy-to-use interfaces to machines and equipment. Proper ergonomic design is necessary to prevent repetitive strain injuries, which can develop over time and can lead to long-term disability.

Portable personal computing devices including transportable wireless tablets like the Apple™ IPad™ brand tablet can be used to electronically record, store and transmit a user's doodles, symbols, shapes and written indicia on a touch screen display. Electronic writing surfaces of the prior art include stylus-activated digitizers, touch pad or screen or touch-screen digitizers such as the write-on screen described in U.S. Pat. No. 7,626,580 (to Keely) entitled “High level active pen matrix” for an electronic digitizer system and stylus input device, and users attempting to input handwriting into any of these devices have the same ergonomic problems as writers writing on paper tablets.

There is a need, therefore, for a convenient, flexible, inexpensive and unobtrusive handwriting system and method with improved ergonomics to increase the comfort and efficiency of handwriting.

### OBJECTS AND SUMMARY OF THE INVENTION

Accordingly, it is an object of the present invention to overcome the above mentioned difficulties by providing a convenient, flexible, inexpensive and unobtrusive system and method to increase the comfort and efficiency of writing, for both right-handed and left-handed writers.

In accordance with the present invention, a novel method and system includes a first set of stationery products including a unique style of lined paper having printed indicia aligned along a first slanted axis that is specifically and uniquely configured to writers who are right-handed. In accordance with the present invention, a second set of stationery products includes a unique style of lined paper having printed indicia aligned along a second slanted axis that is specifically and uniquely configured to writers who are left-handed.

The focus for the system and method of the present invention is to provide improved products and methods for the educational and professional communities. The stationery products of the present invention allow a right or left-handed person to choose a product that is ergonomically optimized for their own bio-mechanical requirements, thus allowing the person to sit up straight while writing, thus projecting a more attentive demeanor. The method and system of the present invention was designed to help guard against the uncomfortable wrist, back, neck and other bodily aches that arise from long writing sessions.

A tablet of ruled pages configured in accordance with the present invention is made from a conventional flexible substrate such as paper, and the printed indicia aligned along the selected slanted axis allows the writer to adopt a more relaxed and naturally aligned body position when writing, thereby increasing the comfort and efficiency of writing.

Alternatively, personal computing devices such as transportable wireless tablets (e.g., the Apple™ IPad™ brand tablet) can be programmed to display a handwriting surface with “lines” or similar indicia aligned along the selected slanted axis and thus allow the writer to adopt a more relaxed and naturally aligned body position when engaged in electronic writing, thereby increasing the comfort and efficiency of that writing. Electronic writing on the tablet permits a user to comfortably electronically record, store and transmit a user's handwriting on a touch screen display. Any electronic writing surface (e.g., stylus-activated digitizers, touch pad or screen or touch-screen digitizers such as the write-on screen described in U.S. Pat. No. 7,626,580 (to Keely) entitled “High level active pen matrix” for an electronic digitizer system and stylus input device, is readily programmed to provide a handwriting sensing and recording surface with displayed slanted lines or other alignment indicia so that users who are handwriting into any of these devices experience more comfortable ergonomics as when the system of the present invention is used by writers writing on paper tablets. Preferably, a “netbook” transportable computer or a web-enabled tablet such as an IPad is programmed to function as a handwriting sensing and recording surface configured to permit a user to select a selected configuration of slanted lines or other alignment indicia so that a right-handed or left-handed user can select appropriate alignment indicia (e.g., slanted, spaced lines oriented for the user's ergonomic needs) and then handwrite into the device.

The above and still further objects, features and advantages of the present invention will become apparent upon consideration of the following detailed description of a specific embodiment thereof, particularly when taken in conjunction with the accompanying drawings, wherein like reference numerals in the various figures are utilized to designate like components.

### DESCRIPTION OF THE FIGURES

FIG. 1 illustrates a writer's typical efforts at bending the body and angling the (prior art) writing surface or stationery product to compensate for the mis-match between the writer's body movements and the writing surface or stationery product's ruled lines.

FIG. 2 illustrates an ergonomically enhanced handwriting alignment and recording surface comprising a ruled writing surface or stationery product configured for a right-hand user and the ergonomically enhanced method for writing, in accordance with the present invention.

FIG. 3 illustrates an ergonomically enhanced handwriting alignment and recording surface comprising ruled stationery product configured for a left-hand user and the ergonomically enhanced method for writing, in accordance with the present invention.

FIG. 4 illustrates another ergonomically enhanced handwriting alignment and recording surface comprising ruled stationery product configured for a right-hand user, to facilitate the ergonomically enhanced method for writing, in accordance with the present invention.

FIGS. 5-14 illustrate alternative embodiments of the ergonomically enhanced handwriting alignment and recording surface comprising ruled stationery products configured for a specific user, to facilitate the ergonomically enhanced method for writing, in accordance with the present invention.

FIG. 15 illustrates an ergonomically enhanced handwriting alignment and recording surface comprising a ruled envelope configured for a left-hand user, to facilitate the ergonomically enhanced method for writing, in accordance with the present invention.

FIG. 16 illustrates an ergonomically enhanced handwriting alignment and recording surface comprising a ruled envelope configured for a right-hand user, to facilitate the ergonomically enhanced method for writing, in accordance with the present invention.

FIG. 17 illustrates an ergonomically enhanced handwriting alignment and recording surface comprising a ruled postcard configured for a left-hand user, to facilitate the ergonomically enhanced method for writing, in accordance with the present invention.

FIGS. 18-21 illustrate alternative embodiments of an ergonomically enhanced handwriting alignment and recording surface comprising printed handwriting tablet pages or stationary configured to facilitate the ergonomically enhanced method for writing, in accordance with the present invention.

FIG. 22 illustrates an ergonomically enhanced handwriting alignment and recording surface comprising a ruled memo pad stationery product configured for a right-hand user, to facilitate the ergonomically enhanced method for writing, in accordance with the present invention.

FIG. 23 illustrates an ergonomically enhanced handwriting alignment and recording surface comprising a ruled memo pad stationery product configured for a left-hand user, to facilitate the ergonomically enhanced method for writing, in accordance with the present invention.

FIGS. 24 and 25 illustrate an ergonomically enhanced handwriting system with an electronic handwriting sensing and recording surface which is programmed to display slanted alignment indicia and is selectively configured for either a right-hand or a left-hand user to facilitate the ergonomically enhanced method for writing of the present invention.

FIGS. 26 and 27 are schematic diagrams illustrating functional blocks of exemplary implementations of the components of the system of FIG. 24.

FIG. 28 is a flowchart illustrating the operation of FIG. 24's tablet device as a user-configurable ergonomic writing surface, in accordance with the method of the present invention.

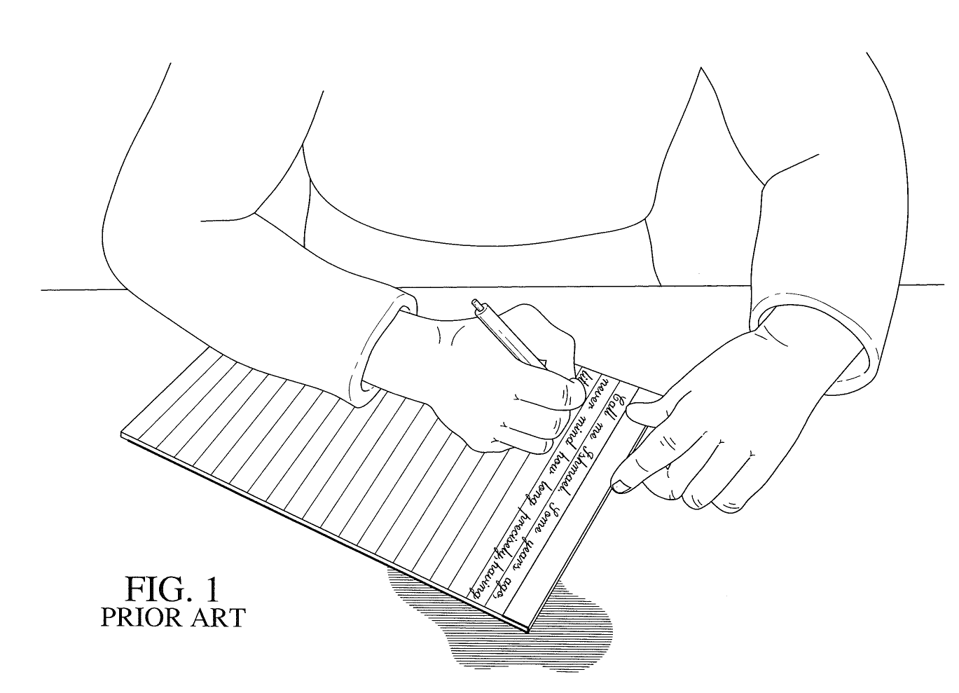

### DETAILED DESCRIPTION OF THE PREFERRED EMBODIMENT

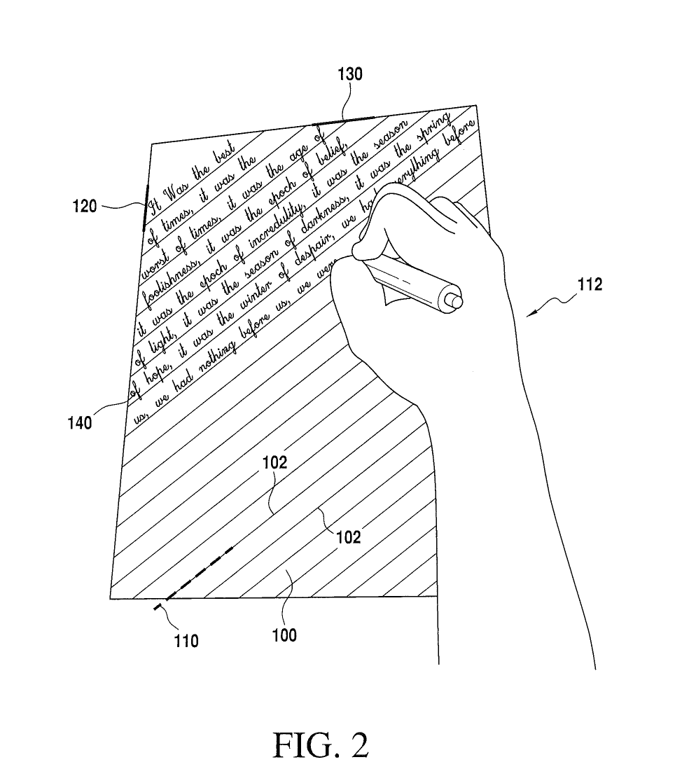

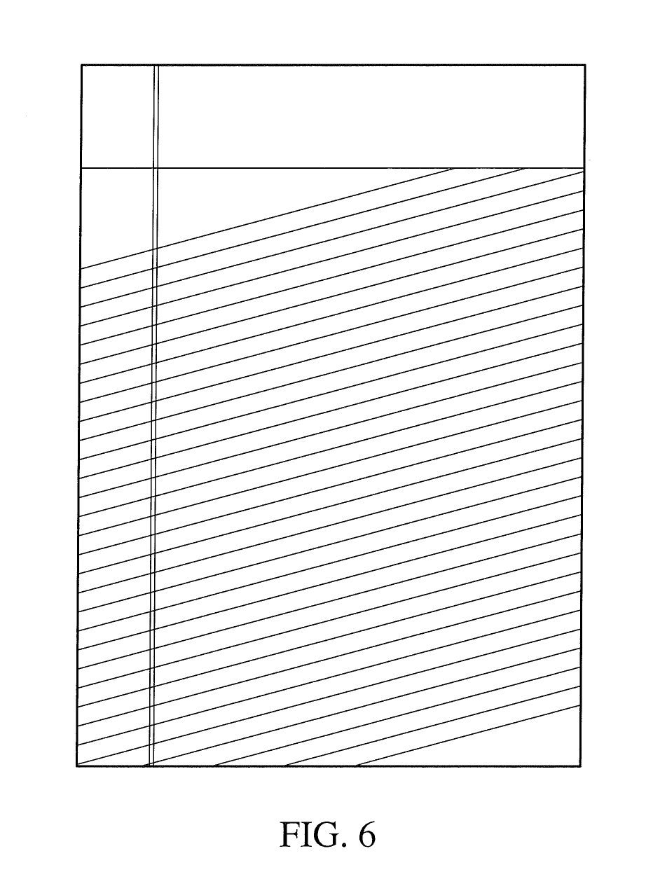

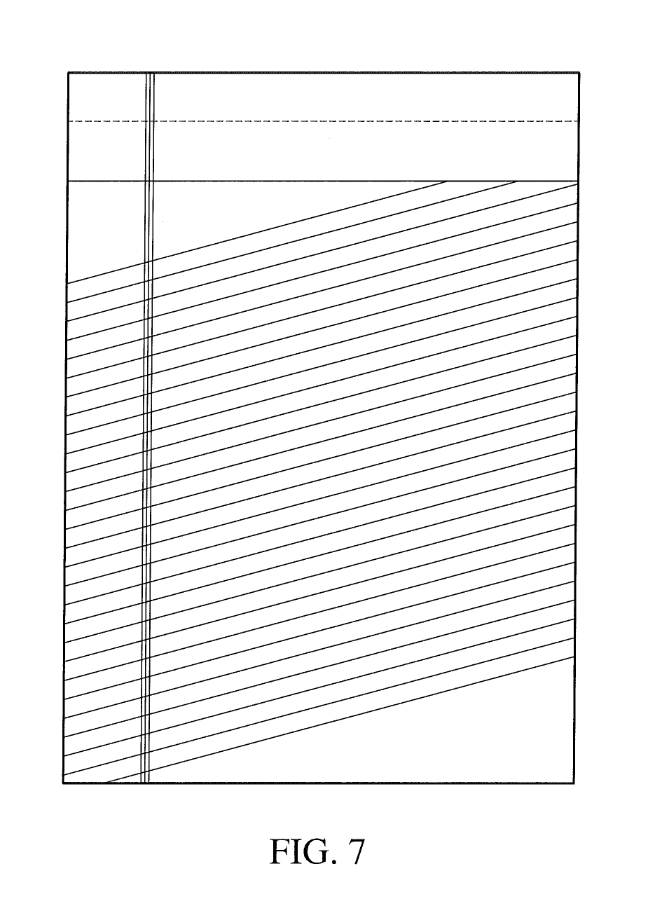

As best seen in FIGS. 2-7, in accordance with the system and method of the present invention, a first ergonomically enhanced handwriting alignment and recording surface comprises a lined paper substrate 100 having a plurality of parallel spaced lines or aligned printed indicia 102 aligned along (or parallel with) a first slanted axis 110 that is specifically and uniquely configured to promote a comfortable arc-like motion for writers 112 who are right-handed. Flexible substrate 100 is preferably made from a commercially available bulk material such as paper. The first substrate or paper 100 is embossed or imprinted with a first plurality of substantially linear, parallel spaced printed indicia or ruled lines 102 which are aligned along first slanted axis 110, on a first slant angle (e.g., 15 degrees), as compared to a vertical or horizontal reference line, such as the straight left edge 120 or top edge 130 of the page.

The first slant angle for the ruled lines is preferably in the range of 10 degrees to 45 degrees; and the first slanted axis has an upward slope or rises (left to right), thereby allowing a right-handed writer to adopt a more relaxed and naturally aligned body position and promote a comfortable arc-like motion for writer 112 when writing, thereby increasing the comfort and efficiency of handwriting.

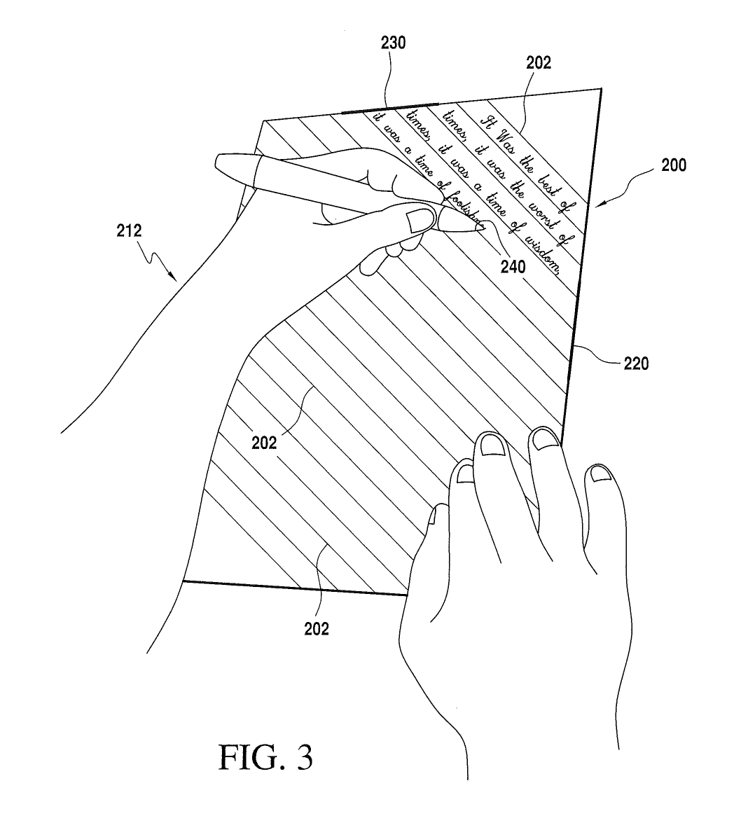

The ergonomically enhanced handwriting alignment and recording surface 100 illustrated in FIG. 2 makes a user-fitted method for handwriting possible. In the method of the present invention, the mechanics of handwriting writing for user or writer 112 who is right-handed first involves determining or selecting whether the user or writer will write right handed (as shown) or left handed (see FIG. 3), and if writer 112 is writing right handed; then writing surface 100 is selected to include a first plurality of substantially linear, parallel spaced printed handwriting alignment indicia 102 aligned along a first slanted axis, on a first slant angle, as compared to a first writing surface vertical or horizontal reference line (e.g., 130); wherein said first slant angle is in the range of 10 degrees to 45 degrees; and wherein said first slanted axis rises (left to right) for right handed user or writer 112. Next, as shown in FIG. 2, one position's the user's or writer's right forearm and hand substantially along the right side of the writing surface 100; and Then, as shown, user 112 writes along the printed indicia 102 at the first slant angle using a naturally aligned body position when writing, thereby increasing the comfort and efficiency of writing. The user's handwriting 140 is illustrated as being aligned between parallel handwriting alignment indicia 102.

In accordance a related embodiment of the present invention as shown in FIG. 3, a second ergonomically enhanced handwriting alignment and recording substrate or paper 200 for left handed handwriting has printed indicia aligned along a second slanted axis that is specifically and uniquely configured to writers who are left-handed. The left-handed system and stationery products (e.g., 200) uniquely configured to writers who are left-handed, and so comprise a second ergonomically enhanced handwriting alignment and recording surface with lined paper substrate 200 having a plurality of parallel spaced lines or aligned printed indicia 202 aligned along (or parallel with) a first slanted axis 210 that is specifically and uniquely configured to promote a comfortable arc-like motion for writers 212 who are left-handed. Flexible substrate 200 is preferably made from a commercially available bulk material such as paper. The second substrate or paper 200 is embossed or imprinted with a second plurality of substantially linear, parallel spaced printed indicia or ruled lines 202 which are aligned along second slanted axis 210, on a first slant angle (e.g., 15 degrees), as compared to a vertical or horizontal reference line, such as the straight right edge 220 or top edge 230 of the page.

The second slant angle for the ruled lines 202 is preferably in the range of 10 degrees to 45 degrees; and the second slanted axis has a downward slope or falls (left to right), thereby allowing a left-handed writer 212 to adopt a more relaxed and naturally aligned body position and promote a comfortable arc-like motion for writer 212 when writing, thereby increasing the comfort and efficiency of handwriting. The left-handed user's handwriting 240 is illustrated as being aligned between parallel handwriting alignment indicia 202.

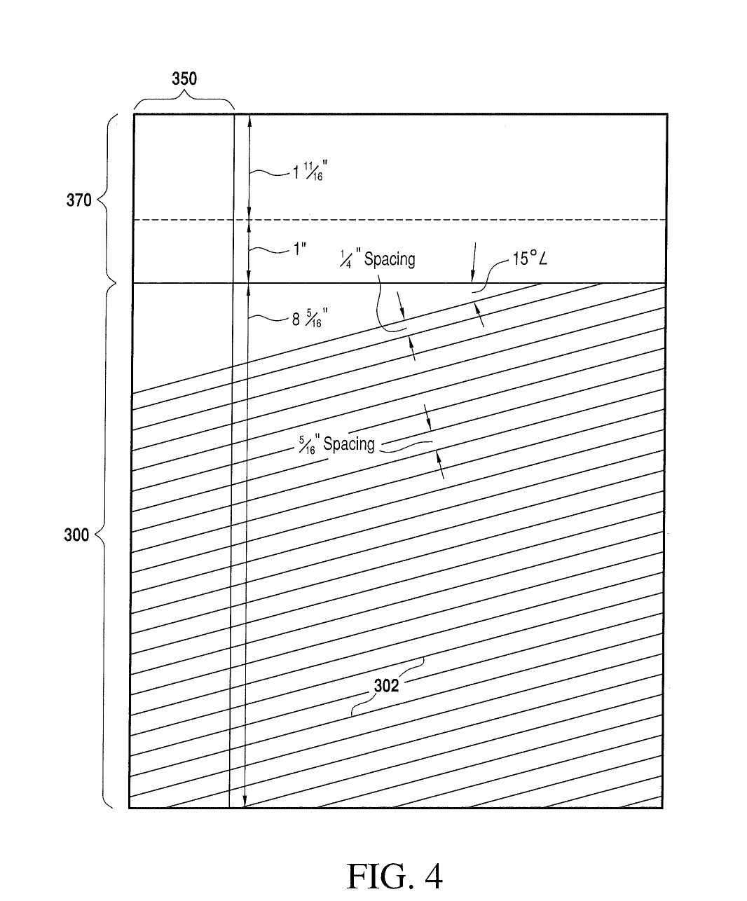

Turning now to FIG. 4, a printed page includes a first region 300 configured to receive the handwriting or hand rendered marks (e.g., with slanted ruled lines 302) and adjacent to and bounding the first region 300 is a second region 350 which provides a visible guide or margin, where the second region 350 is defined by a margin line 360. The first region 300 also optionally includes an upper and/or lower un-marked region 370 (e.g., with no slanted ruled lines), which provides blank space and allows the writer to more easily discern the proper hand and arm alignment to be used when writing. FIG. 4 shows an ergonomically enhanced handwriting alignment and recording surface comprises a lined paper substrate having a plurality of parallel spaced lines or aligned printed indicia 302 aligned along (or parallel with) a fifteen degree (15°) slanted axis that is specifically and uniquely configured to promote a comfortable arc-like motion for writers who are right-handed. The substantially linear, parallel spaced printed indicia or ruled lines 302 which are optionally provided at either a first spacing (e.g., one quarter inch apart) or a second larger spacing (e.g., 5/16ths of an inch) aligned along spaced parallel axes at the selected slant angle (e.g., 15 degrees), as compared to a vertical reference line 360. The first slant angle for the ruled lines 302 is preferably in the range of 10 degrees to 45 degrees; and the first slanted axis has an upward slope or rises (left to right), thereby allowing a right-handed writer to adopt a more relaxed and naturally aligned body position and promote a comfortable arc-like motion for writer when writing, thereby increasing the comfort and efficiency of handwriting.

In accordance with the present invention, the method to enhance the mechanics of writing for students or writers who are right-handed, includes the following method steps: first, providing a first writing surface (e.g., 100) such as a flexible substrate made from a commercially available bulk material such as paper; then, embossing or imprinting the first substrate with a first plurality of substantially linear, parallel spaced printed indicia (e.g., 102) aligned along a first slanted axis, on a first slant angle, as compared to a vertical or horizontal reference line (such as the straight top or left edge of the paper). The first slant angle is in the range of 10 degrees to 45 degrees; and, as above, the first slanted axis rises (left to right). Next, the user, instructor or writer initially positions the student or writer (e.g. 112) with their writing hand substantially aligned along the right side of the page; and the student or writer then marks or writes progressively along the printed indicia at the first slant angle using a comfortable arc-like motion while aligning body.

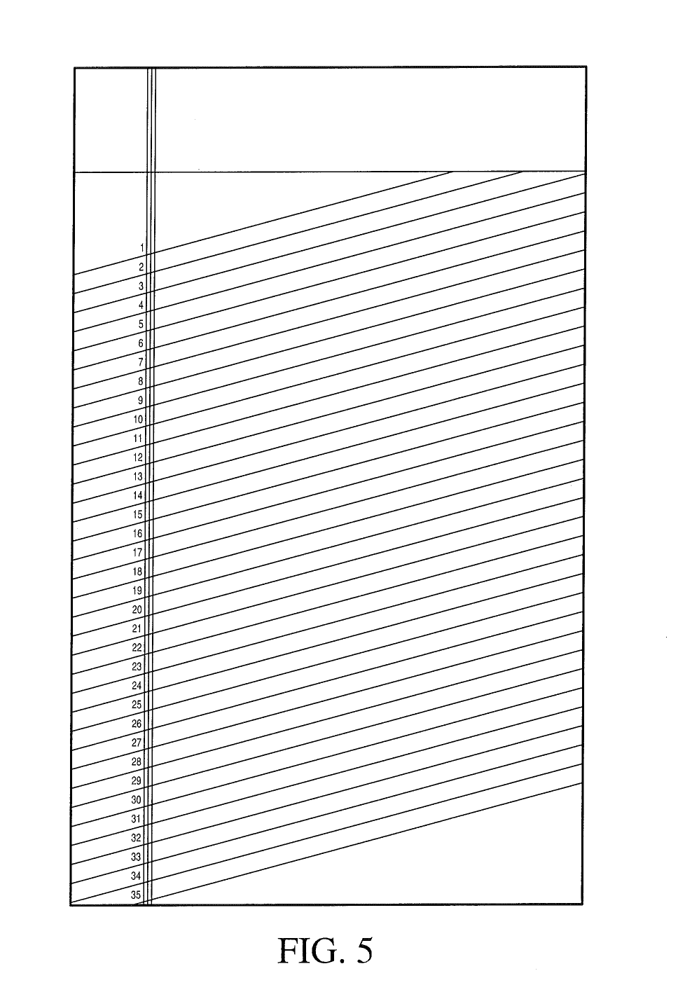

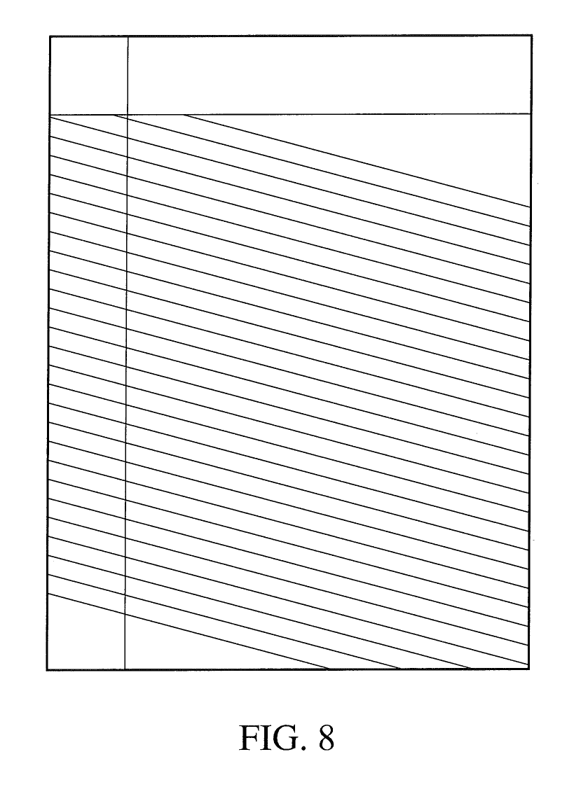

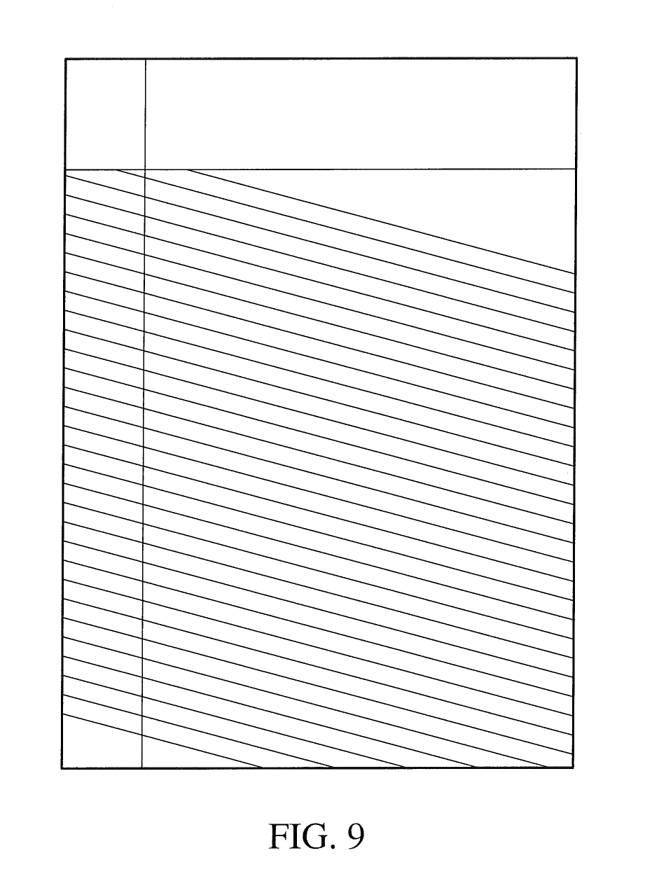

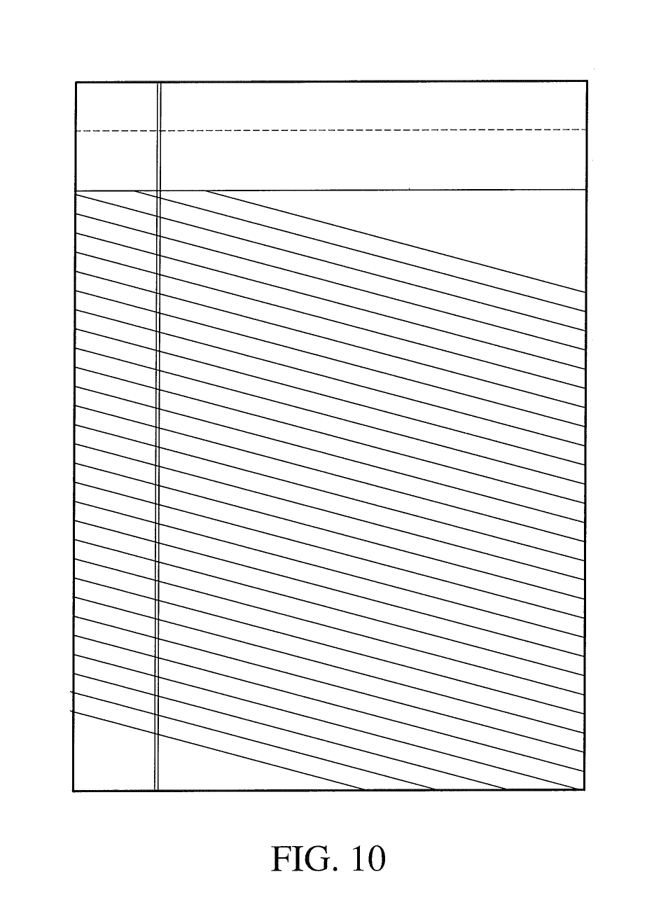

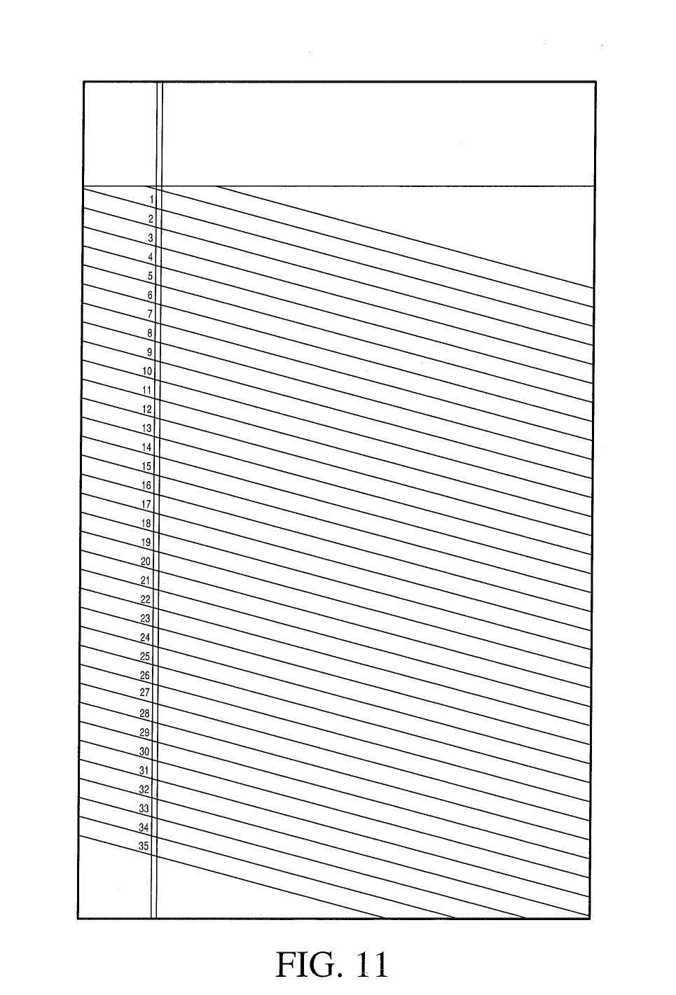

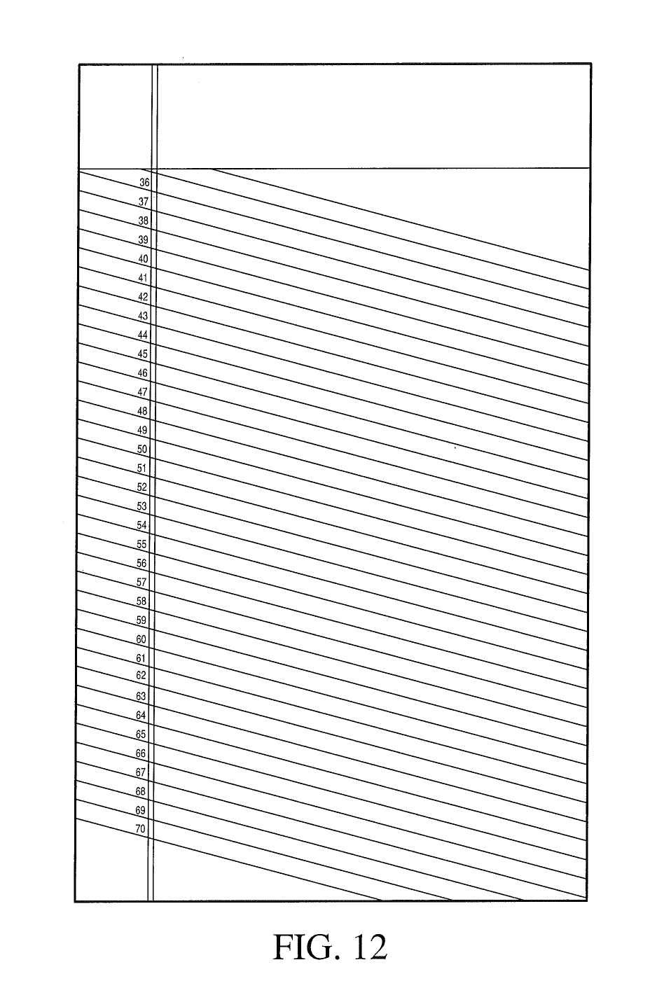

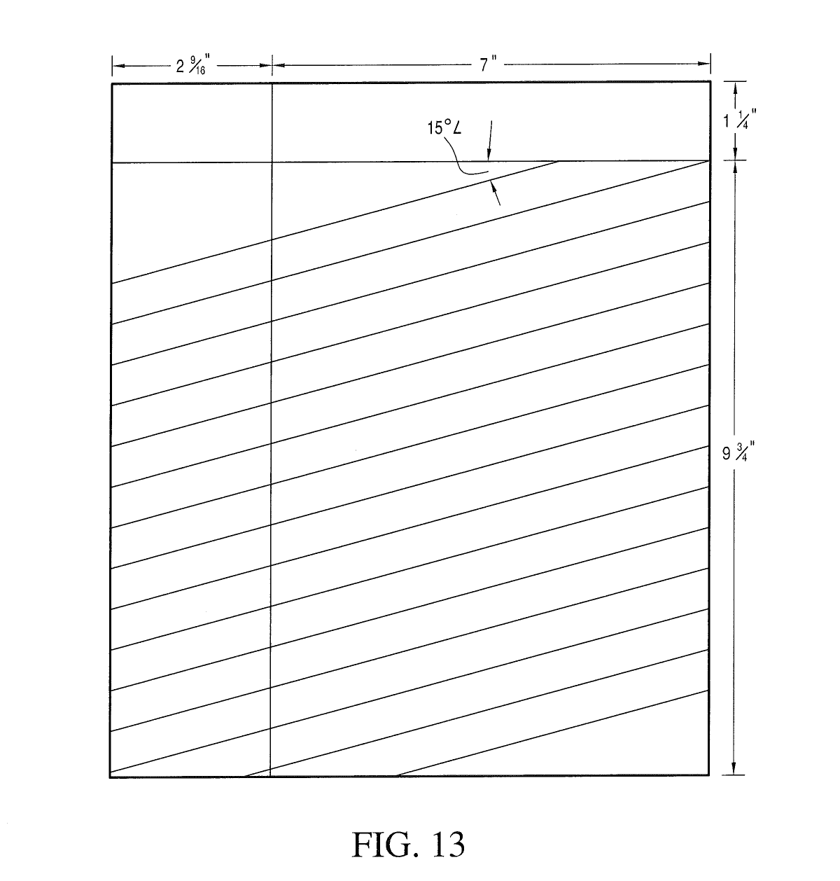

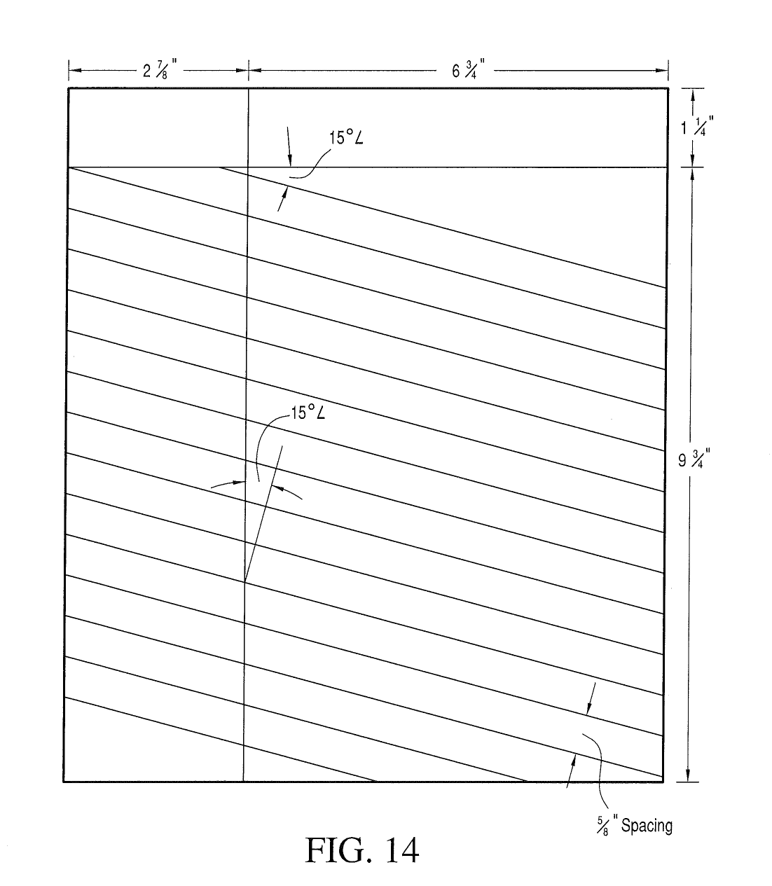

FIGS. 5-14 illustrate other embodiments of ergonomically enhanced handwriting alignment and recording surfaces comprising a lined paper substrate having a plurality of parallel spaced lines or aligned printed indicia aligned along (or parallel with) a slanted axis that is specifically and uniquely configured to promote a comfortable arc-like motion for writers 112 who are right-handed (FIGS. 5-7 and 13) or left handed (FIGS. 8-12 and 14). Each flexible substrate is preferably made from a commercially available bulk material such as paper embossed or imprinted with a plurality of substantially linear, parallel spaced printed indicia or ruled lines which are aligned along a slanted axis on a user-selected slant angle (e.g., 15 degrees), as compared to a vertical or horizontal reference line, such as the straight left edge or top edge of the page, as above.

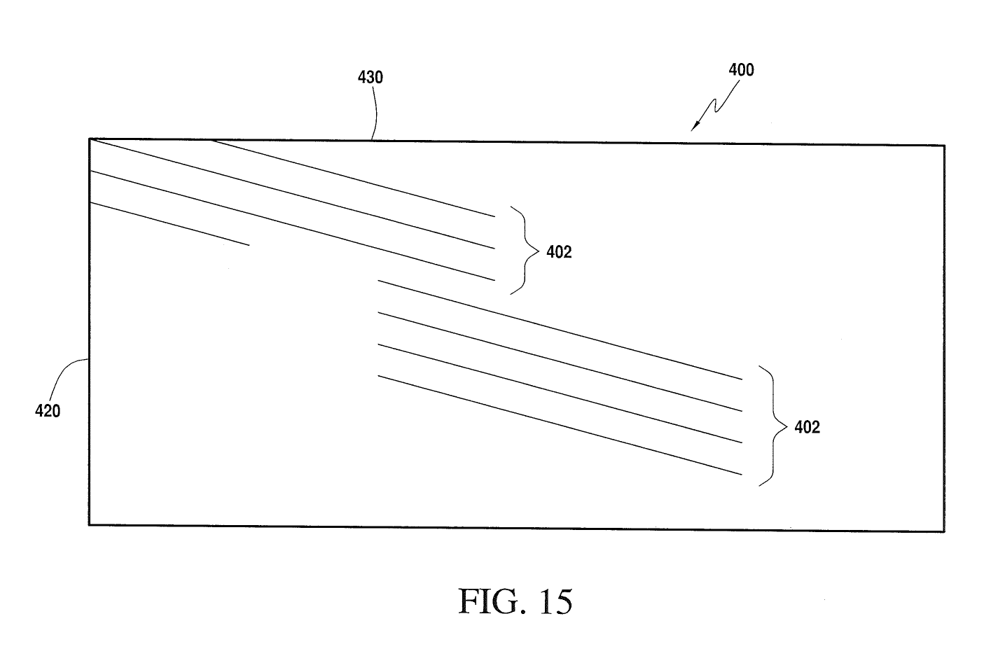

FIG. 15 illustrates an envelope 400 configured to provide an ergonomically enhanced handwriting alignment and recording surface for left handed users and comprises a lined substrate having a plurality of parallel spaced lines or aligned printed indicia 402 aligned along (or parallel with) a slanted axis that is specifically and uniquely configured to promote a comfortable arc-like motion for writers who are left-handed. Envelope 400 is preferably made from a commercially available bulk material such as paper. The envelope's substrate is embossed or imprinted with a first plurality of substantially linear, parallel spaced printed indicia or ruled lines 402 which are aligned along the first slanted axis on a slant angle (e.g., 15 degrees), as compared to a vertical or horizontal reference line, such as the straight left edge 420 or top edge 430 of the envelope. The slant angle for the ruled lines 402 is preferably in the range of 10 degrees to 45 degrees; and the slanted axis has an downward slope or falls (left to right), thereby allowing a left-handed writer to adopt a more relaxed and naturally aligned body position and promote a comfortable arc-like motion when writing, thereby increasing the comfort and efficiency of handwriting.

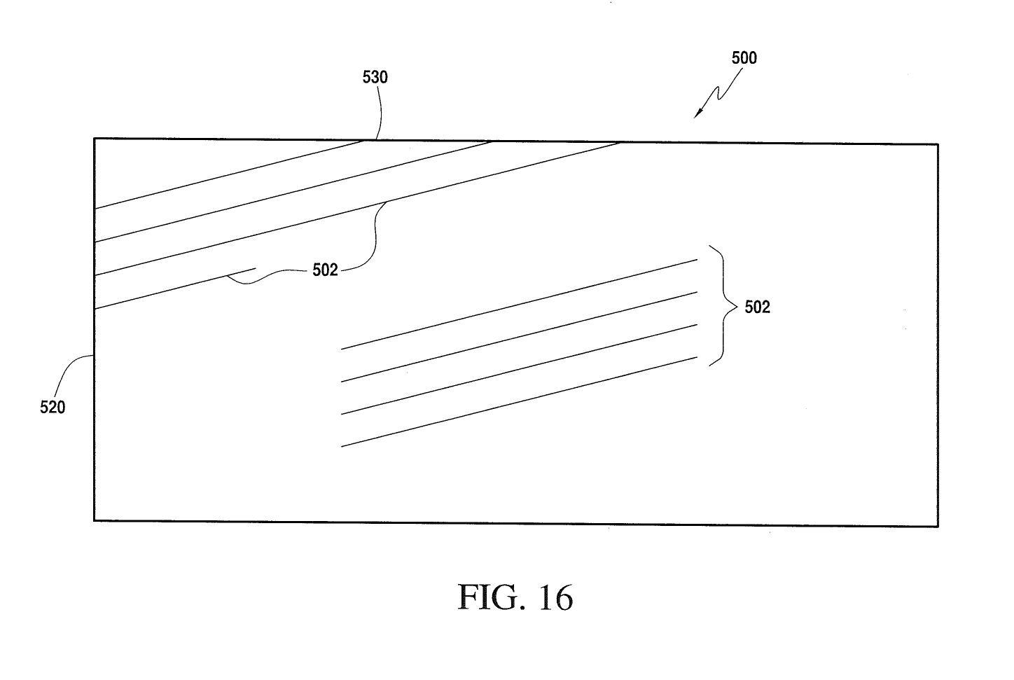

FIG. 16 illustrates an envelope 500 configured to provide an ergonomically enhanced handwriting alignment and recording surface for right handed users and comprises a lined substrate having a plurality of parallel spaced lines or aligned printed indicia 502 aligned along (or parallel with) a slanted axis that is specifically and uniquely configured to promote a comfortable arc-like motion for writers who are right-handed. Envelope 500 is preferably made from a commercially available bulk material such as paper. The envelope's substrate is embossed or imprinted with a first plurality of substantially linear, parallel spaced printed indicia or ruled lines 502 which are aligned along the first slanted axis on a slant angle (e.g., 15 degrees), as compared to a vertical or horizontal reference line, such as the straight left edge 520 or top edge 530 of the envelope. The slant angle for the ruled lines 502 is preferably in the range of 10 degrees to 45 degrees; and the slanted axis has an upward slope or rises (left to right), thereby allowing a right-handed writer to adopt a more relaxed and naturally aligned body position and promote a comfortable arc-like motion when writing, thereby increasing the comfort and efficiency of handwriting.

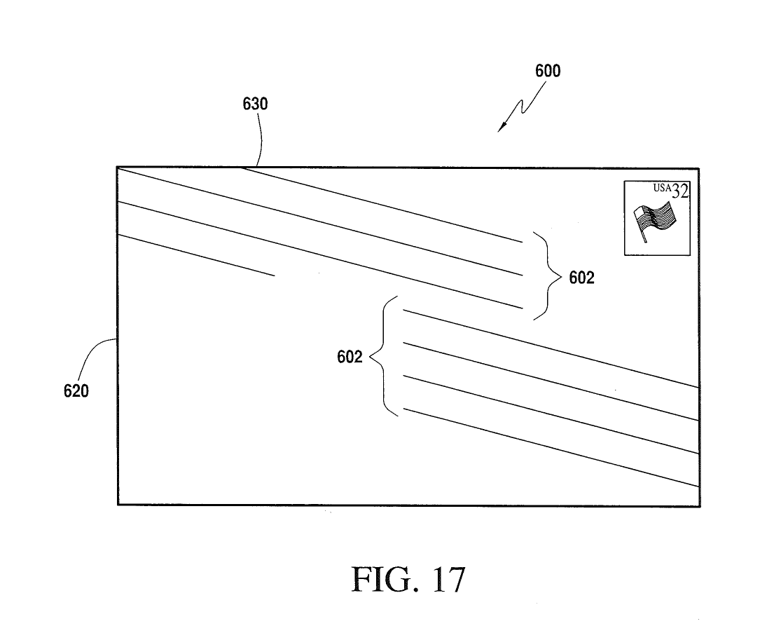

FIG. 17 illustrates a postcard 600 configured to provide an ergonomically enhanced handwriting alignment and recording surface for left handed users and comprises a lined substrate having a plurality of parallel spaced lines or aligned printed indicia 602 aligned along (or parallel with) a slanted axis that is specifically and uniquely configured to promote a comfortable arc-like motion for writers who are left-handed. Postcard 600 is preferably made from a commercially available bulk material such as paper. The postcard's substrate is embossed or imprinted with a first plurality of substantially linear, parallel spaced printed indicia or ruled lines 602 which are aligned along the first slanted axis on a slant angle (e.g., 15 degrees), as compared to a vertical or horizontal reference line, such as the straight left edge 620 or top edge 630 of the envelope. The slant angle for the ruled lines 602 is preferably in the range of 10 degrees to 45 degrees; and the slanted axis has an downward slope or falls (left to right), thereby allowing a left-handed writer to adopt a more relaxed and naturally aligned body position and promote a comfortable arc-like motion when writing, thereby increasing the comfort and efficiency of handwriting.

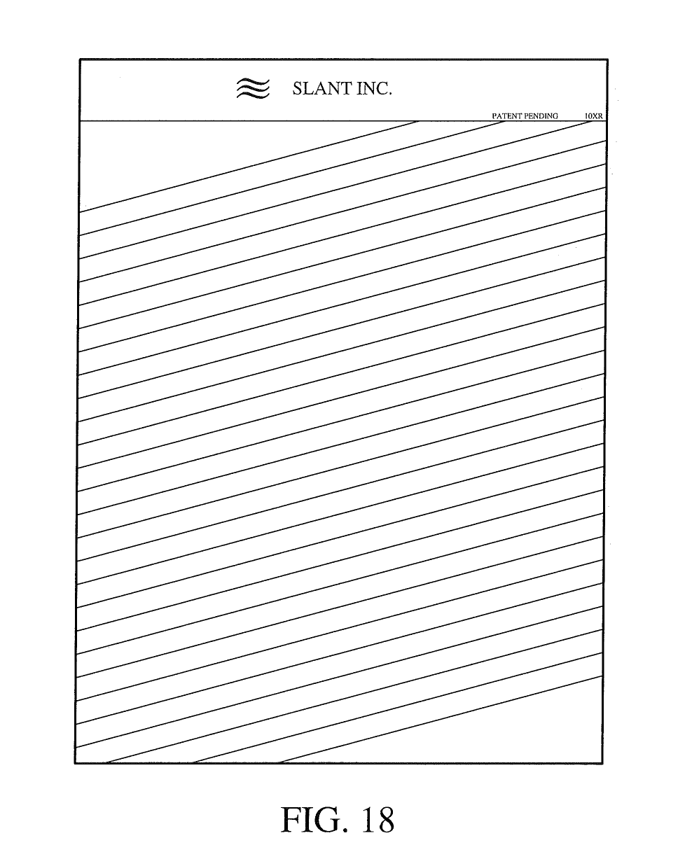

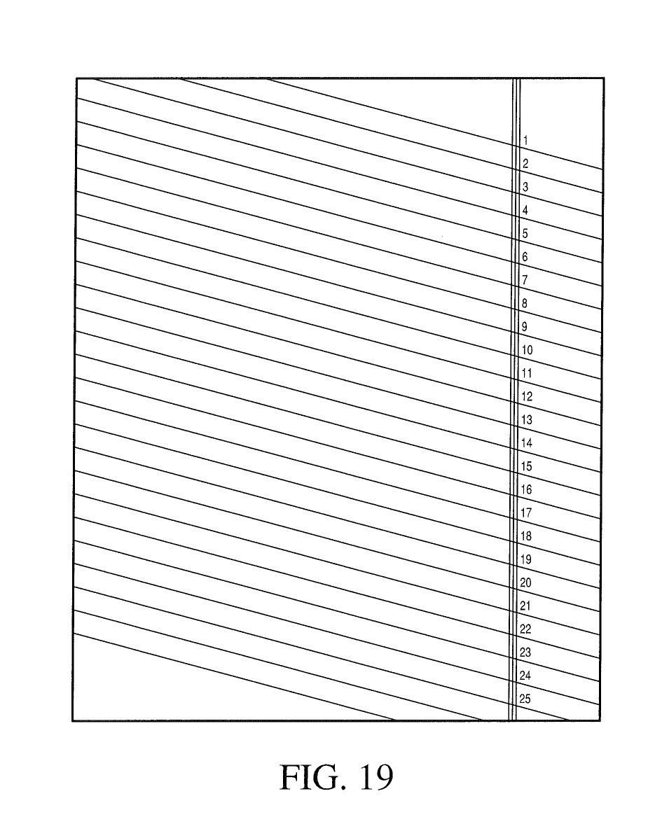

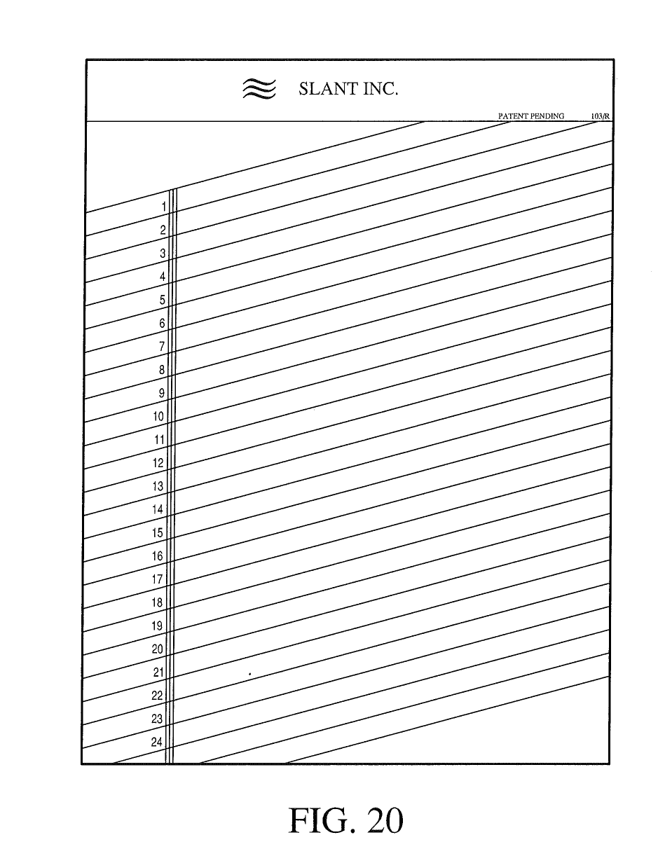

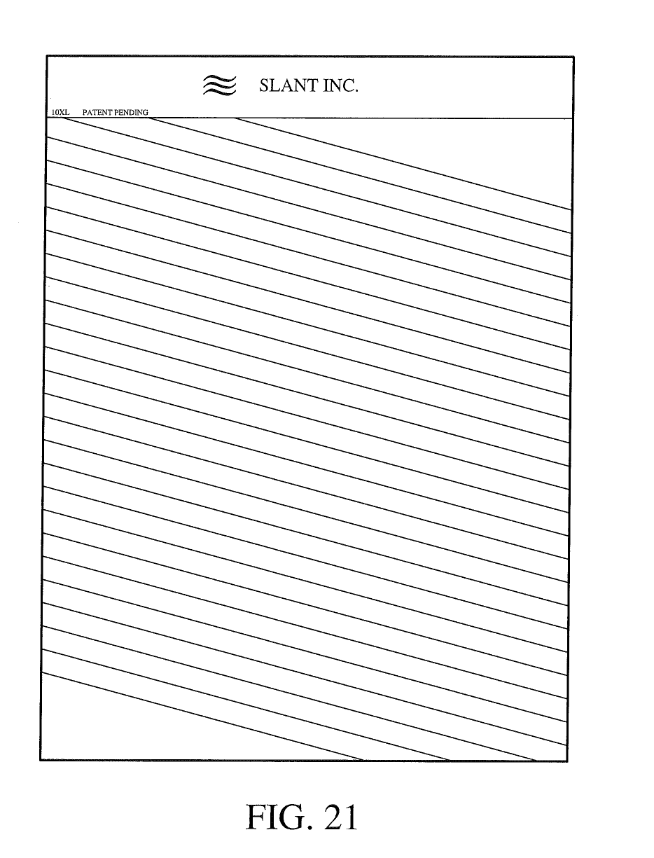

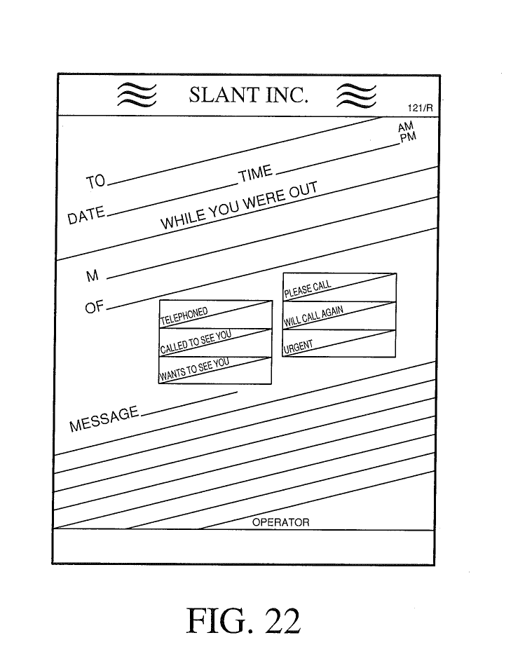

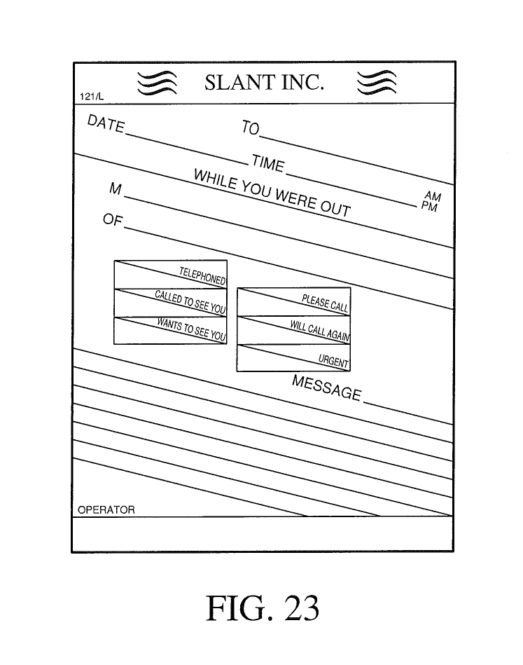

FIGS. 18-23 show alternative embodiments of notepads or pre-printed tablets for handwriting made in accordance with the present invention to provide ergonomically enhanced handwriting alignment and recording surfaces comprising a lined paper substrate having a plurality of parallel spaced lines or aligned printed indicia aligned along (or parallel with) a slanted axis that is specifically and uniquely configured to promote a comfortable arc-like motion for writers (e.g. 112) who are right-handed (FIGS. 18, 20 and 22) or left handed (FIGS. 19, 21 and 23). Each flexible substrate is preferably made from a commercially available bulk material such as paper embossed or imprinted with a plurality of substantially linear, parallel spaced printed indicia or ruled lines which are aligned along a slanted axis on a user-selected slant angle (e.g., 15 degrees), as compared to a vertical or horizontal reference line, such as the straight left edge or top edge of the page, as above.

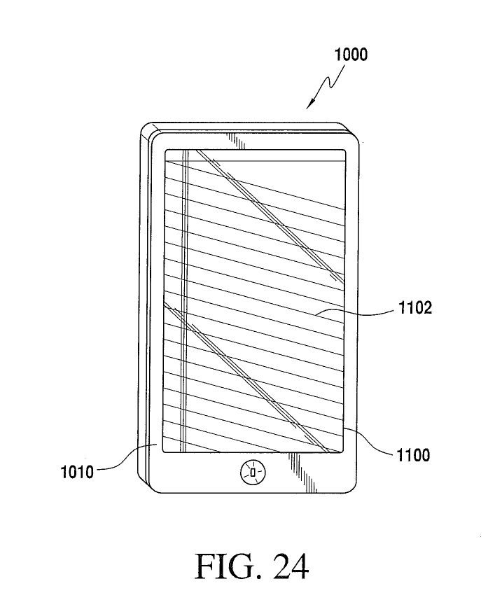

Turning now to the embodiments illustrated in FIGS. 24-28, the system and method are adapted for use with a pre-programmed electronic writing surface such as stylus-activated touch pads or screens or touch-screen digitizers (e.g., such as the write-on screen described in U.S. Pat. No. 7,626,580 (to Keely) entitled “High level active pen matrix” for an electronic digitizer system and stylus input device). Persons of skill in the electronic digitizer/display art, once having been taught about the method and system of the present invention, will readily be able to program a system (e.g., 1000) with an electronic digitizer display 1100 to provide a handwriting surface with aligned indicia or slanted lines 1102 displayed on a first pre-programmed or user-selected slant angle. A user (e.g. 112 or 212) can be prompted to select either a right-handed or left-handed slant for the digitizer display surface 1100 to be written upon.

FIG. 24 illustrates an exemplary handwriting sensing and recording system 1000 which includes an transportable computing device 1010 such as a netbook computer, a tablet or a Smartphone having an ergonomically enhanced handwriting alignment and recording surfaces comprising a touchscreen display 1100 which is programmed to provide an electronic handwriting sensing and recording surface. Transportable device 1010 is programmed to display slanted handwriting alignment indicia 1102 (e.g., or any of the indicia configurations illustrated in FIGS. 2-23) and is selectively configured for either right-hand user 112 or left-hand user 212, to facilitate the ergonomically enhanced method for writing of the present invention. An improved portable tablet computing device 1010 is programmed to permit a user to engage in comfortable handwriting in a similar manner as in the paper tablet products discussed above, while the portable device can also be used as a general computing (e.g., laptop or netbook) device. Preferably, a “netbook” transportable computer or a web-enabled tablet such as an IPad™ is programmed to function as a handwriting sensing and recording surface 1020 configured to permit a user to choose a selected configuration of slanted lines or other alignment indicia so that a right-handed or left-handed user can then use a finger or stylus to simulate a handwriting motion while viewing the user selected alignment indicia (e.g., slanted, spaced lines 102 or 202 oriented for the user's ergonomic needs) and then handwrite into the device's memory.

According to a preferred embodiment of the present invention, the improved portable tablet computing device 1010 comprises a touchscreen display 1020, a housing part 1030 and optionally a pivot and hinge part (not shown). The display screen 1020 may be pivoted to be on the top face of the device 1010 when it is used as an ergonomic writing surface. Writing surface indicia (e.g., 102) may be chosen by any of a plurality of different and unique users by selecting writing surface indicia displayed using a hierarchical user interface. The proposed tablet computing device 1010 is operated as a general purpose computing device when the display screen is in a normal position as a conventional netbook.

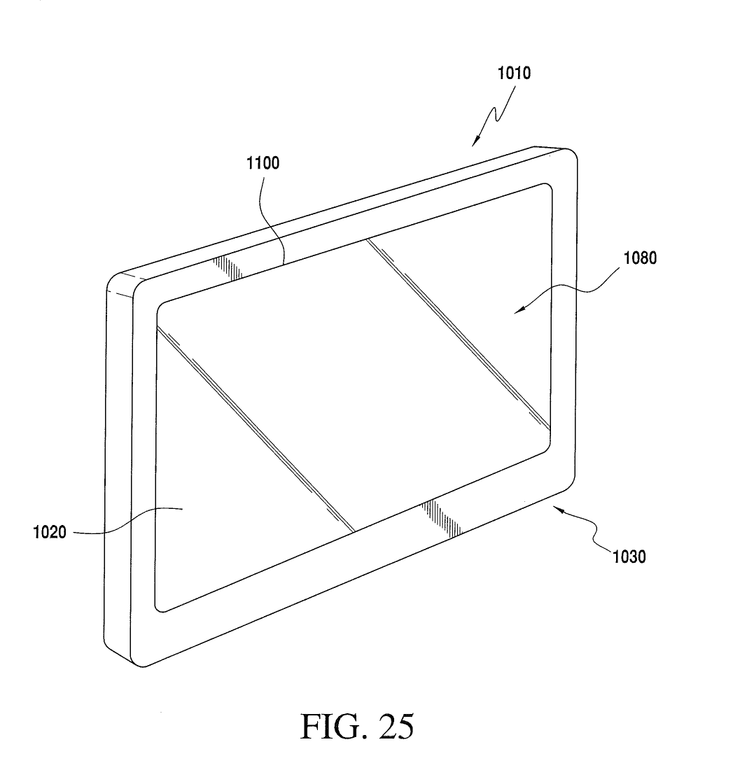

FIGS. 24-25 are diagrams illustrating an exemplary portable computing device 1010 configured for use as a handwriting surface. The device 1010 comprises a display part 1020 supported within a housing part 1030. The display part 1020 further comprises a display screen 1080. According to a preferred embodiment of the present invention, the display screen 1080 is optionally a touchscreen type of LCD. The housing part 1030 may include a keyboard (not shown) and a pointing device (not shown).

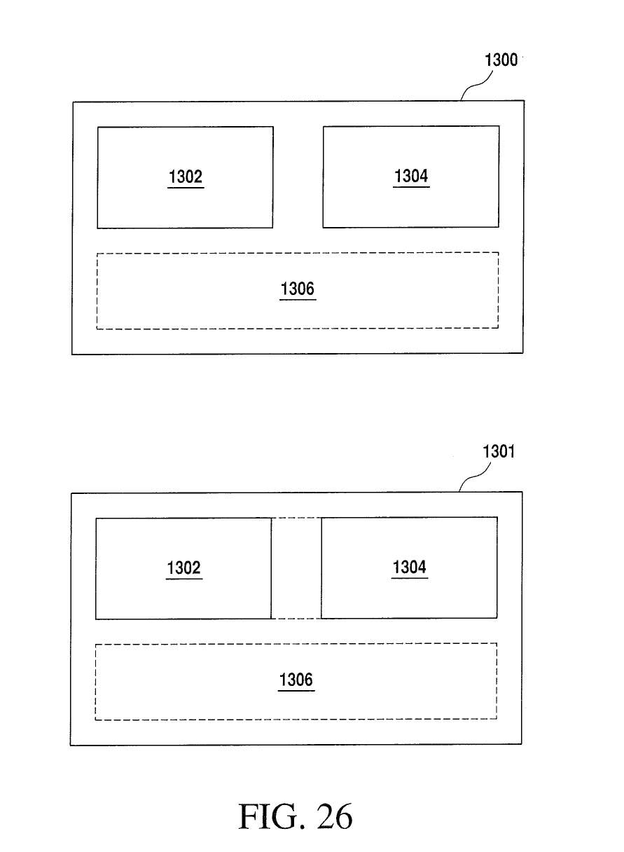

FIG. 26 is a schematic diagram illustrating two different implementations of the device design. As illustrated in 1300, the netbook 1302 and the handwriting sensing and recording surface 1304 may be two different devices in one package sharing the same power supply 1306. As shown in 1301, the netbook 1302 and the handwriting sensing and recording surface 1304 may share some components in additional to sharing the power supply 1306. The shared components may include a memory or storage unit (not shown) and some signal processing units (not shown).

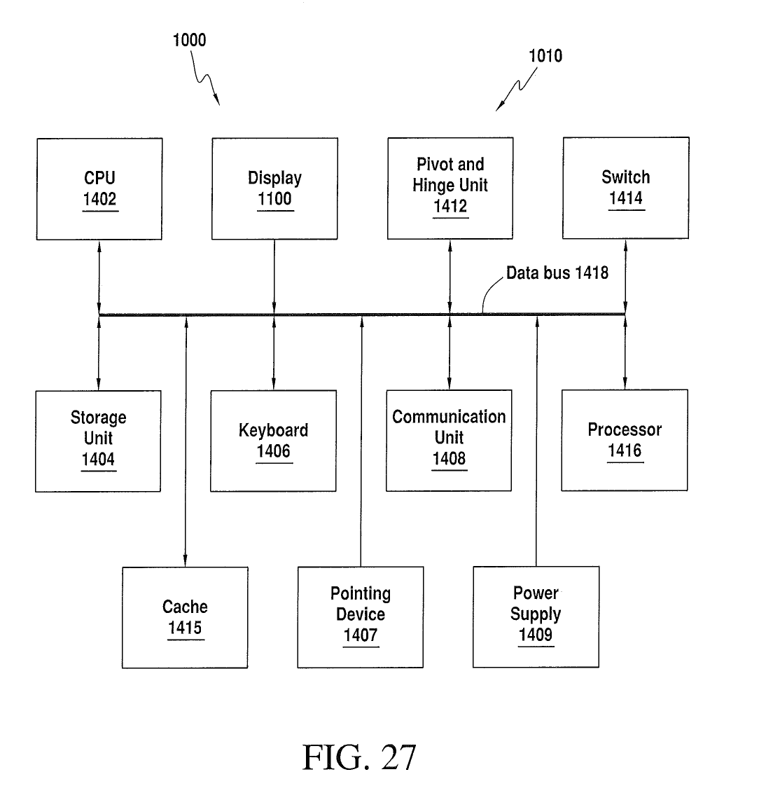

FIG. 27 is a schematic diagram illustrating functional blocks of an exemplary implementation of a transportable tablet or netbook personal computing device 1010. The exemplary portable tablet computing device 1010 comprises a CPU (Central Processing Unit) 1402 for controlling operations of the device. The tablet device 1010 further comprises a storage unit 1404 and a cache memory 1405. The storage unit 1404 may be one or a plurality of flash memory devices. The storage unit 1404 may also be a magnetic storage device. The cache 1405 may be a SRAM (Static Random Access Memory) providing a short access time. The tablet device 1010 also optionally includes input devices such as a keyboard 1406 and a pointing device 1407. A pointing device may be a mouse or a touch-pad. A communication unit 1408 is used to connect the tablet device 1010 to a communication network such as the Internet. The communication network may also be an ad hoc network conforming to various protocols such as Bluetooth or 802.11 Wi-Fi. The power supply 1409 provides power for the operations of the tablet device 1010. The power supply 1409 may be a rechargeable battery in an exemplary case.

Tablet device 1010 includes a display screen 1100 which may be an LCD type of touchscreen display. The display screen 1100 is optionally encased on a net-book style display part supported by a pivot and hinge part 1412. The display screen 1100 may be pivoted to one of two operable positions: one is on the top face of the device and another is in a conventional position for a netbook. A switch 1414 is used to provide a switching means for device to be operated as a dedicated handwriting sensing and recording surface or as a general purpose computing device. Preferably, a handwriting sensing and recording surface processor 1416 may comprise a low power controller or micro-processor, a DSP (Digital Signal Processor) and a CODEC (Coding and Decoding) circuit configured to sense a user's motions on the touchscreen sensor of display 1100. The device 1010 operated as a handwriting sensing and recording surface in system 1000 communicates a user's handwriting as a digital (e.g., image) file over data bus 1418 which provides a means for full duplex or bi-directional high speed data transfer.

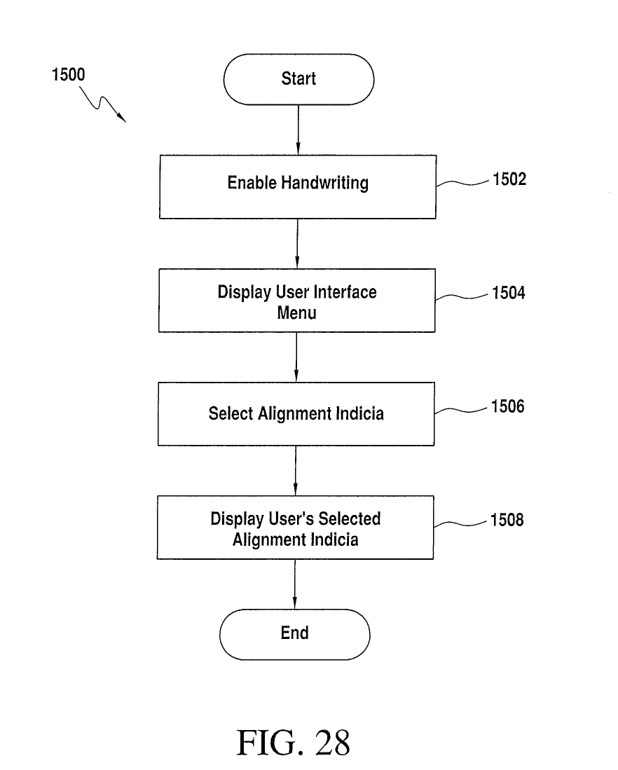

FIG. 28. is a flowchart illustrating software program controlled operation of tablet device 1010 within system 1000 as a dedicated handwriting sensing and recording surface. Handwriting sensing and recording process 1500 starts with step 1502 wherein device 1010 is switched on and a handwriting mode is enabled to provide a dedicated handwriting sensing and recording surface for the user (e.g., 112). As described previously in the present disclosure, display screen 1100 provides a dedicated handwriting sensing and recording surface. A hierarchical user interface with a menu of alignment indicia options (e.g., left-hand slant, right hand slant, line spacing and slant angle) is displayed on the screen in step 1504. The user selects in step 1506 a handwriting sensing and recording surface asset (e.g., a digital file for displaying slanted handwriting alignment indicia as illustrated in FIGS. 3-22, and having left-hand slant, right hand slant, line spacing and slant angle) by using the hierarchical user interface in a progressive manner. The selected handwriting sensing and recording surface asset or Alignment indicia (e.g., 102) is displayed in step 1508. The handwriting sensing and recording surface asset (e.g., a digital file for displaying slanted handwriting alignment indicia as illustrated in FIGS. 2-23) may comprise a video file, a text file, a multimedia file or a movie. The handwriting sensing and recording surface assets may be stored in the storage unit 1404 tablet device 1010. The handwriting sensing and recording surface assets may also be stored in a computing device connected to the tablet device through a communication network such as the Internet. The handwriting sensing and recording surface asset may further be delivered to the tablet device through the Internet. The handwriting sensing and recording surface asset may still further be delivered to the user through an ad hoc communication network conforming to protocols such as Bluetooth or 802.11 Wi-Fi. A user may need to purchase and download the handwriting sensing and recording surface assets which are not owned by the user.

The ergonomically enhanced electronic (e.g., touchscreen enabled) handwriting alignment and recording surface 1100 illustrated in FIGS. 24 and 25 makes a similar user-fitted method for handwriting possible with tablets, smartphones and the like. In the method of the present invention, the mechanics of handwriting writing for user or writer 212 who is left-handed first involves determining or selecting whether the user or writer will write right or left handed (see FIGS. 3 and 24), and if writer 212 is writing left handed; then writing surface 1100 is selected to include a first plurality of substantially linear, parallel spaced printed handwriting alignment indicia 1102 aligned along a first slanted axis, on a downward slant angle, as compared to a first writing surface vertical or horizontal reference line (e.g., the edge or top of display 1100); where the slant angle is in the range of 10 degrees to 45 degrees; and where the slanted axis drops or slopes downwardly (left to right as shown in FIG. 24) for a left handed user or writer 212, and the opposite would be true for the alignment indicia selection made by right handed user 112. Next, as shown in FIG. 3, the left handed user 212 position's the left forearm and hand substantially along the left side of the writing surface 1100 (not shown in FIG. 24), and then user 212 writes along the printed indicia 1102 at the first slant angle using a naturally aligned body position when writing by pressing the finger or a stylus (not shown) upon touchscreen 1100.

As noted above, the focus for the system and method of the present invention (as shown in FIGS. 2-28) is to provide improved products and methods for the educational and professional communities. The stationery products and digital files (for displaying slanted handwriting alignment indicia as illustrated in FIGS. 2-23) of the present invention allow a right or left-handed person to choose a product has the appropriate slant and slant angle to ergonomically optimize their own bio-mechanical writing movement, thus allowing the person to sit up straight while writing, thus projecting a more attentive demeanor and reducing the space required for a comfortable writing session (thereby permitting use of smaller desks, lap writing, and smaller workspaces) the user will experience ease when writing and can select an optimum slant angle for their own writing, thus enhancing ergonomic efficiency and dramatically reducing discomfort and injuries arising from repetitive, awkwardly miss-aligned writing motions.

Having described preferred embodiments of a new and improved writing system method, it is believed that other modifications, variations and changes will be suggested to those skilled in the art in view of the teachings set forth herein. It is therefore to be understood that all such variations, modifications and changes are believed to fall within the scope of the present invention as set forth in the appended claims.

I claim:

1. A handwriting system and product configured for ergonomically optimized use by writers who are right-handed, comprising:
a first writing surface such as a flexible substrate made from a commercially available bulk material such as paper;
wherein the first substrate is embossed or imprinted with a first plurality of substantially linear, parallel spaced handwriting alignment indicia aligned along a first slanted axis, on a first slant angle, as compared to a vertical or horizontal reference line;
wherein said first slant angle is in the range of 10 degrees to 45 degrees; and
wherein said first slanted axis rises (left to right), thereby allowing a right-handed writer to adopt a more relaxed and naturally aligned body position when writing, thereby increasing the comfort and efficiency of writing.

2. The handwriting system of claim 1, wherein the first writing surface comprises an electronic writing surface such as a stylus-activated digitizer or touch-screen digitizer programmed to display said handwriting alignment indicia on a handwriting sensing and recording surface.

3. The handwriting system of claim 2, wherein said handwriting alignment indicia are selected by a right handed user at said user's preferred first slant angle.

4. A system and stationery product uniquely configured to writers who are left-handed, comprising:
a first flexible substrate made from a commercially available bulk material such as paper;
wherein the first substrate is embossed or imprinted with a first plurality of substantially linear, parallel spaced handwriting alignment indicia aligned along a second slanted axis, on a second slant angle, as compared to a vertical or horizontal reference line;
wherein said second slant angle is in the range of 10 degrees to 45 degrees; and
wherein said second slanted axis falls (left to right), thereby allowing a left-handed writer to adopt a more relaxed and naturally aligned body position when writing, thereby increasing the comfort and efficiency of writing.

5. The handwriting system of claim 4, wherein the first writing surface comprises an electronic writing surface such as a stylus-activated digitizer or touch-screen digitizer programmed to display said handwriting alignment indicia on a handwriting sensing and recording surface.

6. The handwriting system of claim 5, wherein said handwriting alignment indicia are selected by a left handed user at said user's preferred first slant angle.

7. A method to enhance the mechanics of handwriting writing for users or writers who are either right-handed or left handed, comprising:
(a) providing a first writing surface;
(b) selecting whether said user or writer is writing right handed or left handed; and
(c) if said writer is writing right handed; displaying upon or imprinting upon said first writing surface a first plurality of substantially linear, parallel spaced printed handwriting alignment indicia aligned along a first slanted axis, on a first slant angle, as compared to a first writing surface vertical or horizontal reference line; wherein said first slant angle is in the range of 10 degrees to 45 degrees; and wherein said first slanted axis rises (left to right) for a right handed user or writer.

8. The method of claim 7, further comprising:
(d) positioning the user's or writer's right forearm and hand substantially along the right side of the first writing surface; and
(e) writing along the printed indicia at the first slant angle using a naturally aligned body position when writing, thereby increasing the comfort and efficiency of writing.

9. The method of claim 7, wherein said first writing surface comprises a flexible substrate made from a commercially available bulk material such as paper embossed or imprinted with said first plurality of substantially linear, parallel spaced printed indicia to define an ergonomically enhanced handwriting alignment and recording surface.

10. The method of claim 7, wherein said first writing surface comprises an electronic handwriting sensing and recording surface, and further comprising the method steps of:
(d) positioning the user's or writer's right forearm and hand substantially along the right side of the electronic handwriting sensing and recording surface; and
(e) writing by touching or using a stylus upon said electronic handwriting sensing and recording surface to create electronically sensed and displayed handwriting which is aligned along the displayed indicia at the first slant angle using a naturally aligned body position when writing, thereby increasing the comfort and efficiency of writing.

11. The method of claim 7, further comprising:
(d) if said writer is writing left handed; displaying upon or imprinting upon said first writing surface a first plurality of substantially linear, parallel spaced printed handwriting alignment indicia aligned along a second slanted axis, on a second slant angle, as compared to said writing surface vertical or horizontal reference line; wherein said second slant angle is in the range of 10 degrees to 45 degrees; and wherein said second slanted axis falls (left to right) for the left handed user or writer.

12. The method of claim 11, further comprising:
(e) positioning the user's or writer's left forearm and hand substantially along the left side of the first writing surface; and
(f) writing along the printed indicia at the second slant angle using a naturally aligned body position when writing, thereby increasing the comfort and efficiency of writing.
